(19) United States
(12) Patent Application Publication
(10) Pub. No.: US 2020/0167850 A1
(43) Pub. Date: May 28, 2020

(54) SYSTEM AND METHOD FOR DISTRIBUTION OF CUSTOMIZED ORDERS

(71) Applicant: Toshiba America Business Solutions, Inc., Lake Forest, CA (US)

(72) Inventors: Lee Michael SULLIVAN, Lake Forest, CA (US); Joseph CONTRERAS, Lake Forest, CA (US); Daniel BALLESTEROS, Lake Forest, CA (US)

(21) Appl. No.: 16/210,782

(22) Filed: Dec. 5, 2018

Related U.S. Application Data
(60) Provisional application No. 62/772,585, filed on Nov. 28, 2018.

(51) Int. Cl. G06Q 30/06; G06Q 20/20; G06K 19/06; G06K 7/14

(52) U.S. Cl. CPC G06Q 30/0635; G06K 7/1413; G06K 19/06028; G06Q 20/208

(57) ABSTRACT

A system and method for distribution of customized orders includes a display and an item pickup platform. The item pickup platform is configured to be disposed on a service counter and includes a plurality of item pickup positions, each item pickup position configured to accept one or more prepared items for pickup by a customer. An associated scanner scans the labels of prepared items, and the display identifies the associated pickup positions on the item pickup platform for customers to retrieve prepared items.

### CROSS-REFERENCE TO RELATED APPLICATIONS

This application claims the benefit of U.S. Provisional Application No. 62/772,585 filed Nov. 28, 2018 which is incorporated herein by reference.

### TECHNICAL FIELD

This application relates generally to a pick up queue for retrieving customized order. The application relates more particularly to a pick up queue having display elements to provide order status and pickup information.

### BACKGROUND

Many coffee shops take customer orders at a register and then provide customers with their individual orders at a designated pick up counter once their beverages have been made by a barista. Some coffee shops also accept online orders received over the Internet. To ensure that each customer receives the correct order the customer's name can be added to the order, for example by writing the customer's name on the cup at the time of ordering. Once a barista has completed making the customer's beverage the barista can read out loud the name on the cup to announce to waiting customers that their beverage is ready and available for pickup. In some instances, once a beverage is ready for pickup, the barista may simply call out the beverage being served, such as “large peppermint mocha.” In this instance, there may be two or more people awaiting the same beverage, and it quite possible that someone may take a beverage ahead of their turn in the queue.

This informal method can lead to customer confusion and requires customers to pay constant attention to hear when their name is called. For example, if the customer's name is difficult to pronounce a barista may have difficulty properly announcing the availability of their beverage to the waiting customer, especially if the barista was not the person who original took the order and didn't overhear the proper pronunciation of the customer's name. Customer may also not hear the announcement, for example if the customer is not paying close attention, is engaged in conversation, has hearing difficulties, or if the environment is too loud to hear clearly. Online customers arriving at the coffee shop may have to search among completed orders to see whether their order has been made. For many customers, having another customer touch their awaiting beverage can be viewed as unsanitary.

### BRIEF DESCRIPTION OF THE DRAWINGS

Various embodiments will become better understood with regard to the following description, appended claims, and accompanying drawings wherein:

FIG. 1 is a perspective view of an example embodiment of a coffee venue having a smart shelf;

FIG. 2 is a perspective view of a first example embodiment of a smart shelf item pickup platform;

FIG. 3 is a perspective view of a second example embodiment of a smart shelf item pickup platform;

FIG. 4 is a top view of an example embodiment of a smart mat item pickup platform;

FIG. 5 is an example embodiment of a digital computing device; and

FIG. 6 is a flowchart of example operations of an embodiment of a system for distributing customized orders.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

In a first example embodiment, a method includes scanning indicia associated with an item of a customer order, for example a bar code of a label attached to a beverage, placing the item on an item pickup position of an item pickup platform, and displaying indicia for directing a customer to the item pickup position on the item pickup platform.

In a second example embodiment, a system includes an item pickup platform configured to be placed on a counter, an associated scanner, and a display. The item pickup platform includes multiple item pickup positions for holding one or more items of a customer order that are available for pickup. The scanner is configured to scan indicia of prepared items that are ready for pickup by customers and the display is configured to identify the corresponding item pickup position on the item pickup platform for the prepared items.

In a third example embodiment, a system includes a scanner configured to scan indicia associated with an item of a customer order, an item pickup platform that includes multiple item pickup positions for holding one or more items of a customer order that is available for customer pickup, and a display configured to direct customers to items placed on the item pickup positions of the item pickup platform. The system further includes a processor that receives data from the scanner when the items are scanned. The processor determines the item pickup positions for the items of the customer order, generates display data that includes indicia associated with the customer order and the item pickup position, and transmits the display data to the display.

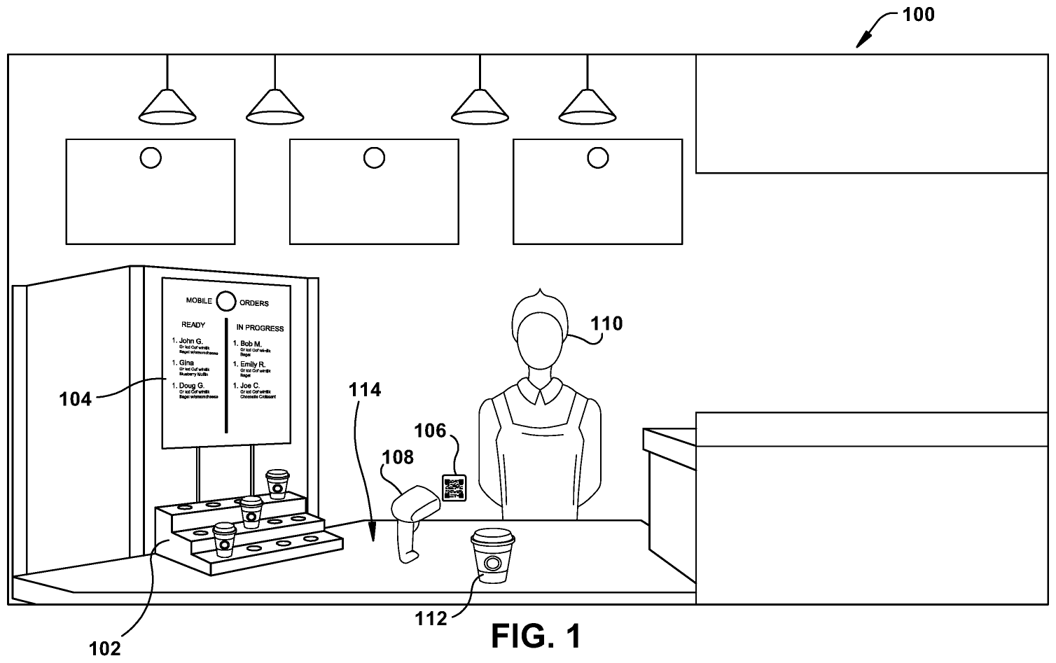

Referring to FIG. 1, an example embodiment of a coffee venue 100 having a smart shelf is presented. The mobile pickup queue includes an order pickup display 104 and an item pickup platform 102 that is a smart shelf. The display 104 and item pickup platform 102 can be configured so as to fit on existing pickup counters used in many coffee shops and other fast service venues. A barista 110 prepares a customer order that can include one or more items 112, such as a coffee cup as shown. Once the barista 110 has prepared an item 112, the barista 110 can scan a label 106 attached the item 112 using a scanning device 108 such as a bar code scanner. The barista 110 places the item on the item pickup platform 102 and the display 104 provides order status information for customers waiting to pick up their order.

The display 104 can provide multiple views, which can be displayed side-by-side (as illustrated) or sequentially viewed one after another, or in any other desirable pattern or groupings. The views can be sized appropriately to facilitate viewing by customers. The size and position of the views can be based on the size of the display, and can be scaled appropriately for the venue.

For example, a first view can include prepared beverages that are awaiting customer pickup from the item pickup platform 102. A second view can include a queue of beverages that are in the process of being made by baristas. Other views can be included as would be understood in the art. For example, a separate view can be generated for mobile order customers who order online or using their mobile devices. Such a view can include the customers' desired future pickup times. The mobile orders can be presented as a separate view, or included in one of the other views (for example with a time stamp for customer pickup.)

The views can include customer and other information. For example, for a view of prepared beverages information such as the customer's name, a description of each beverage, a timestamp, the location on the smart shelf, and so forth can be provided. For the queue, information such as the customer's name, a description of each beverage, a number indicating the current position on the queue, a projected wait time, and so forth can be provided. A graphic can also be provided to provide non-written information. This may be particularly useful to customers who are literacy challenged or speakers of a different language. By way of particular example, a graphic may show relative cup size or fill level, and may include a graphic of steam arising from the cup when the beverage is hot, or ice cubes at the bottom of the cup if it is cold.

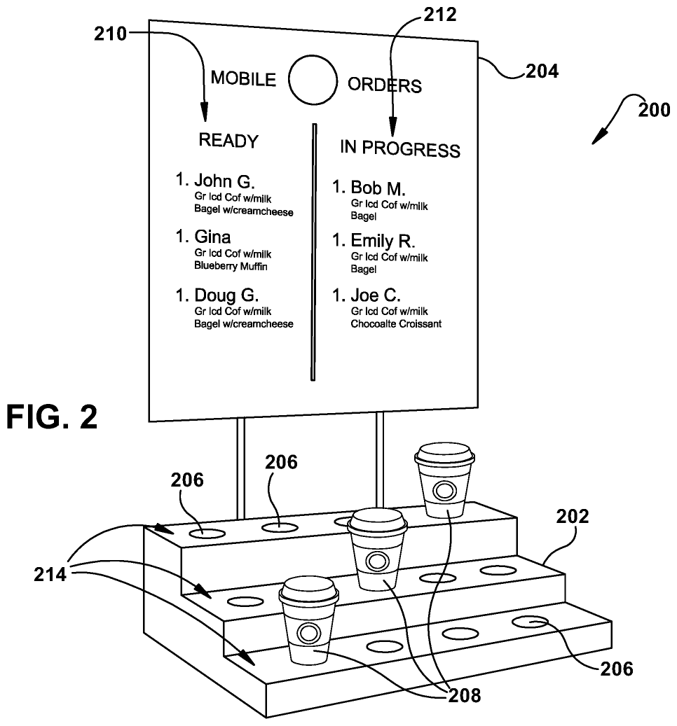

Referring now also to FIG. 2, a perspective view of a smart shelf 200 is presented. An item pickup platform 202 works in concert with the display 204 to provide information to customers and baristas. In embodiments, the item pickup platform 202 can detect as beverages 208 or other ordered items are added or removed from the item pickup platform 202. In embodiments, item pickup positions 206 can include display elements such as color coded spots or selectable lights to assist customers and baristas with retrieving or placing the beverages 208 on the item pickup platform 202. For example, when a customer's order is first taken, a bar coded label can be attached to a beverage 208 as described above for FIG. 1. When a barista has prepared the beverage 208, the barista can scan the bar code label on the beverage 208. The views presented on the display 204 can be updated based on the scanned bar code, for example by removing the associated order from the queue 212 of beverages to be made and moving the order to a list 210 of prepared beverages available for pickup by customers.

In embodiments, when the barista scans the bar coded label on a beverage 208 the item pickup platform 202 can illuminate the appropriate item pickup position 206 on the item pickup platform 202 thereby providing an indication to the barista as to where to place a prepared beverage 208. The list 210 of prepared orders on the display 204 can be updated to show where the customer's beverage 208 is located, thereby assisting the customer with locating their beverage 208 and other items without having search for, and potentially touch, other customers' items. When the barista is preparing multiple beverages 208 for the same customer order, the item pickup platform 202 can group those beverages 208 together on the item pickup platform 202, for example by providing indications to the barista to place those beverages 208 on the same shelf 214 or in proximity with other items in the same customer order. This not only assists the customer when retrieving prepared beverages 208 associated with their order, but it also frees the barista from having to keep track of which beverages 208 need to be grouped together. This feature helps to minimize interruptions and allows the barista to focus on order fulfillment.

In embodiments, when a barista scans a bar coded label on the prepared beverage 208 and places the beverage 208 on an open item pickup position 206 on the item pickup platform 202, the item pickup platform 202 can detect the placement and position of the beverage 208. The display 204 can then be updated with this information which helps to direct the customer to their prepared beverage 208 on the item pickup platform 202. For example, the item pickup platform 202 can include labels, colors, or other display elements to assist customers and the list of prepared beverages can be updated to direct the customer to the shelf 214 and item pickup position 206 of their beverage 208 on the item pickup platform 202 based on indicia or colors displayed on the item pickup platform 202 or via the display elements.

In embodiments, the display 204 can include a touchscreen such that when the customer or barista selects an order on the display 204 that selection causes a light on the item pickup platform 202 to illuminate as a visual indication to the customer as to where to locate their prepared beverage 208. If the customer ordered multiple items, lights associated with each of those items can be illuminated simultaneously. If some of the customer's items are still being prepared, the queue 212 on the display can highlight any items not yet prepared and placed on the item pickup platform 202.

In embodiments, the display 204 and item pickup platform 202 can highlight an order automatically. For example, as each prepared beverage 208 is placed on the item pickup platform 202, a light on the item pickup platform 202 can be illuminated and corresponding orders on the display 204 can be highlighted. Advantageously, this change on the display 204 can alert customers to view the display 204 and see whether their beverage 208 has been prepared or is still in the queue 212. For example, if a customer wasn't certain if a barista had called out their name, the customer can view the display 204 to see the status of their particular order. In some instances, the display 204 and the item pickup platform 202 can eliminate the need for a barista to call out customer names altogether, affording the customer more privacy and eliminating embarrassments over mispronunciations. Advantageously, the display 204 assists people with hearing disabilities and can allow a coffee venue to better meet standards of the American with Disabilities Act.

In embodiments, the display 204 and item pickup platform 202 can highlight ready orders, for example by sequentially illuminating a light under each order or prepared beverage 208 and simultaneously highlighting the associated order on the display 204. This advantageously can alert customers that their order has been prepared and is ready for pickup. In another example embodiment, haptic feedback may be provided, such as having a particular cup holder area vibrate so as to be detectable by someone visually impaired. In another example, the display is comprised of a Braille display, such as a Braille touchscreen. A Braille display can simultaneously display both visible information as well as raised dots. In still a further example, haptic feedback can direct a customer to a location, and they can confirm their identity by touch.

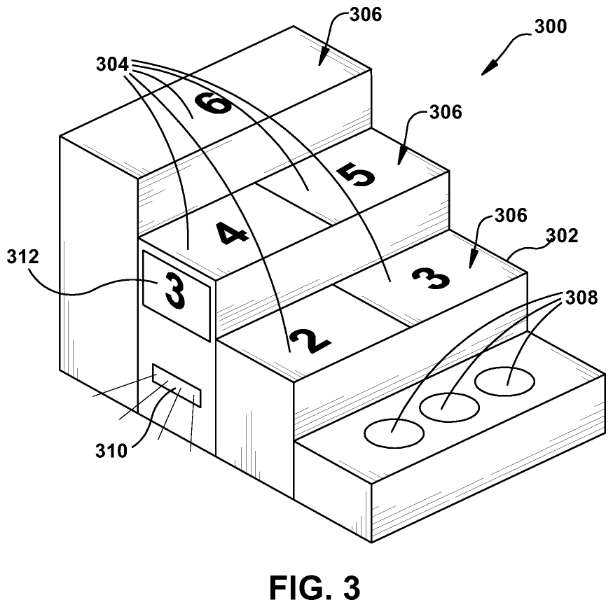

Referring now to FIG. 3, a second example embodiment of a smart shelf 300 is illustrated. The item pickup platform 302 can include numbered item pickup positions 304 disposed on two or more shelves 306. Display elements 308 can be used to provide information to baristas and customers. The item pickup platform 302 can include an integrated scanner 310. Advantageously, the integrated scanner 310 allows a barista to scan a prepared beverage or other item without having to pick up a separate bar code scanner. In operation, a barista brings a prepared item into proximity of the integrated scanner 310 and the bar code on the prepared item is automatically scanned by the integrated scanner 310. The item pickup platform 302 can provide indications to the barista as to which item pickup position 304 to place the item upon. In an embodiment, indicia can be displayed on a screen display element 314, for example by displaying a number corresponding to a number associated with one of the item pickup positions 304.

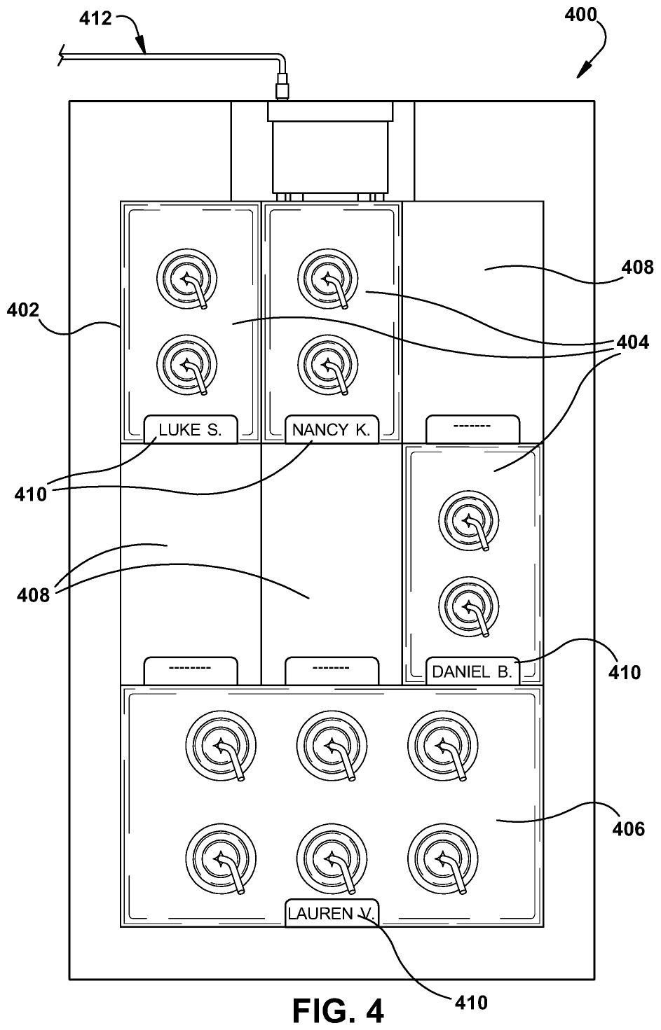

Referring now also to FIG. 4, an example embodiment a smart mat 400 is presented. The smart mat can be placed on an existing countertop of a fast service venue and can provide information similar to the smart shelves of FIGS. 1, 2, and 3. The smart mat 400 includes an item pickup platform 402 that includes regions 404, 406, and 408 for placing different customer orders. For example, the item pickup platform 402 can include multiple smaller regions 404, 408 for individual beverage orders or orders having only a few items, and one or more larger regions 406 for larger orders having multiple items. The item pickup platform 402 can include display elements such as graphical display elements 410 for displaying customers' names as well as indicator lights surrounding the regions 404, 406, 408 for highlighting specific orders. The item pickup platform 402 can include one or more pressure sensitive elements to detect when an item has been placed on the item pickup platform 402, for example a pressure sensitive element can be associated with each region 404, 406, 408.

Advantageously, the smart mat 400 allows non-drink items, such as sandwiches or pastries, to be grouped together with the rest of the customer's order. For example, larger items can be positioned adjacent to beverages placed on the smart mat 400. In embodiments, the smart mat 400 can determine which regions 404, 406, 408 should be used for different customer orders to ensure best use of the smart mat 400.

Similar to the smart shelf described above for FIGS. 1, 2, and 3, the smart mat 400 can be configured to have different modalities depending upon the use case. In an example configuration, any open regions 408 without items can be left unilluminated until an item is placed on the open region 408. In another example configuration, when a barista scans an item the appropriate region 404, 406, 408 can be illuminated to assist the barista with placing that item in the appropriate region 404, 406, 408. For example, if the item is the first or only item of an order to be prepared, one of the open regions 408 can be illuminated. If the items are part of a larger order that includes other items that have already been prepared, the region 404, 406 associated with other items can be illuminated. The display elements can assist baristas with placing items together that belong to a common order. If the barista accidentally attempts to put a scanned item into the wrong region, for example a region 404, 406 associated with a different order, the smart mat 400 can illuminate that region 404, 406 using a different color, for example red, to alert the barista to their mistake.

In another example configuration, the smart mat 400 can detect when items of an order are placed in a particular region 404, 406, 408 on the smart mat 400. In an example configuration, pressure sensitive elements can detect when an item has been placed on one of the open regions 408, and the graphical display element 410 can display the customer's name associated with the item. If a barista scans the bar code for a beverage and places the scanned item on the smart mat 400, the associated graphical display element 410 can be updated with the customer's name. In another example configuration, when a pressure sensitive element detects that an item is being added to or removed from one of the regions 404, 406 a suitable action can be taken. For example, the display can highlight the customer order to provide feedback to customers. Advantageously, this helps to ensure that customers are picking up their own order and not another customer's order.

In embodiments, the display, smart shelf, or smart mat can include one or more audible elements. The audible elements, which can include an integrated speaker or the like, can be configured to generate sounds to alert customers to changes and provide feedback to baristas. For example, when a customer's order is completed and ready for pickup, an audible element can sound a chime to alert customers to view the display and retrieved their completed order. In another example, if a barista attempts to group items together from separate orders on the smart mat, or places a beverage in the wrong position on the smart shelf, a tone can be sounded to alert the barista to their mistake. As would be understood in the art, specific features described above for the smart mat can be incorporated into the smart shelf, or vice versa.

In embodiments, the display, smart shelf and/or smart mat can be an independent stand-alone system, which can facilitate integration with existing coffee shops. In embodiments, the display, smart shelf and/or smart mat can be integrated with back-office systems present in a coffee shop.

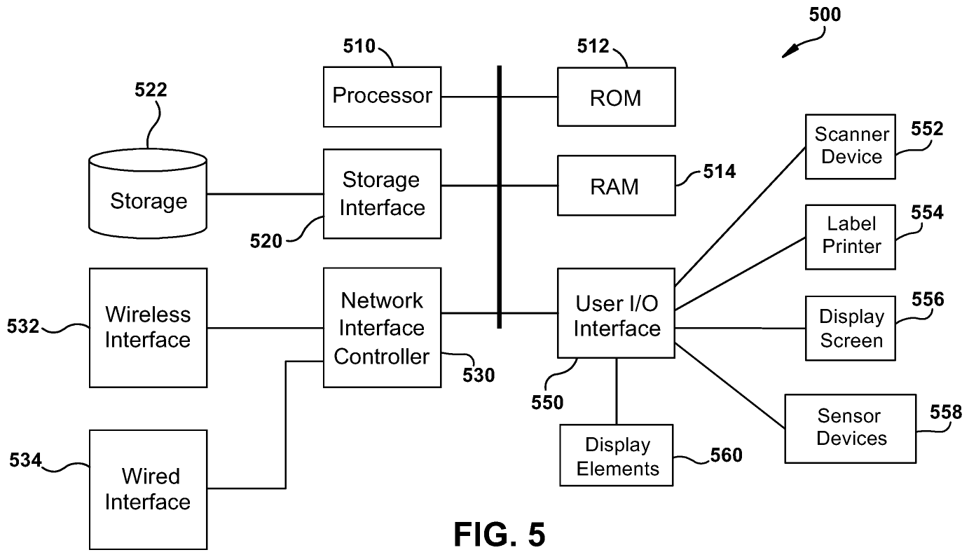

The display, smart shelf and/or smart mat can include one or more suitable digital computing devices to perform operations. Referring to FIG. 5, an example digital computing device 500 is presented. Included are one or more processors, such as that illustrated by processor 510. Each processor is suitably associated with non-volatile memory, such as read only memory (ROM) 512 and random access memory (RAM) 514, via a data bus. Processor 510 is in data communication with a storage interface 520 for reading or writing to a data storage system 522, suitably comprised of a hard disk, optical disk, solid-state disk, or any other suitable data storage as will be appreciated by one of ordinary skill in the art.

Processor 510 is also in data communication with a network interface controller (NIC) 530, which provides a data path to any suitable wired or physical network connection via physical network interface 534, or to any suitable wireless data connection via wireless interface 532, such as one or more of the networks detailed above. Such network communications can be used to communicate with back-office systems or a point of sale system used by baristas to take customer orders. Other communications, such as by USB or universal serial bus, are similarly contemplated.

Processor 510 is also in data communication with a user input/output (I/O) interface 550 which provides data communication with peripherals, such as the scanner 552, a label printer 554, the display screen 556, sensor devices 558, or display elements 560 associated with the smart shelf or smart mat.

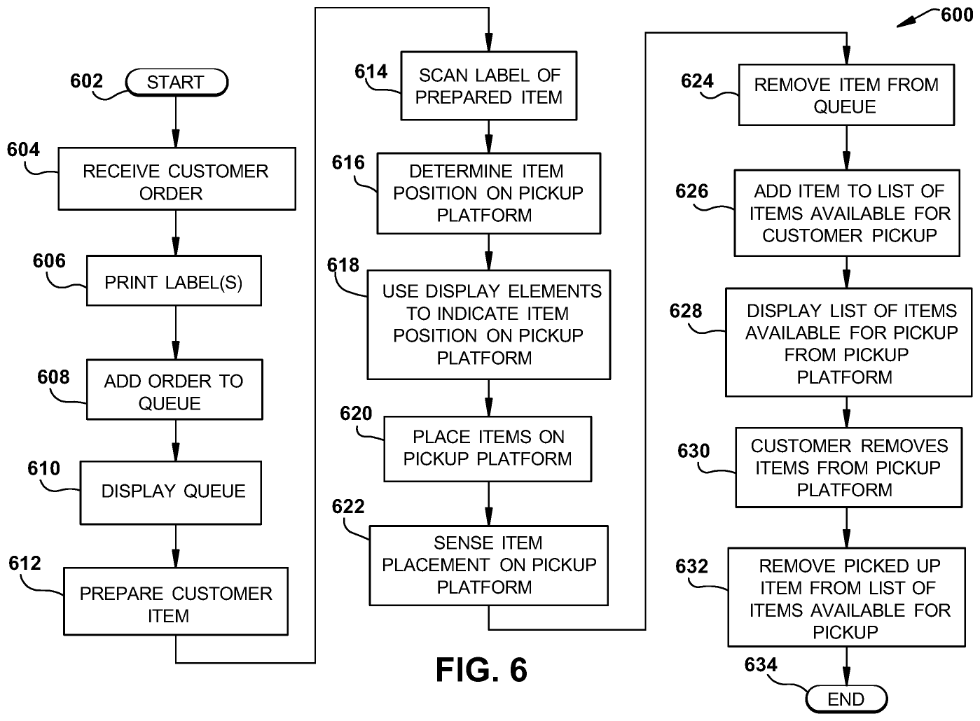

FIG. 6 is a flowchart 600 of example operations of a system for distributing customized orders. Operation commences at start block 602 and proceeds to block 604 where a customer order is received. At block 604, labels can be printed and attached to individual items of the customer order. For example, if the customer ordered a beverage item that needs to be prepared by a barista, a label can be printed and secured to an appropriately-sized empty beverage cup. The label can include any suitable information, such as the customer name, a description of the item, and machine readable code such as a bar code or QR code.

At block 608, the order can be added to the queue of items in progress and at block 610 the queue can be updated and displayed on an associated display. The displayed queue advantageously allows customers to keep track of the progress of their order while the items are being prepared at block 612.

When an item has been prepared and is ready for customer pickup, the barista scans the label at block 614. At block 616 the system optionally determines the item pickup position on the pickup platform and provides a visual indication to the barista of the item pickup position at block 618, for example as described above in greater detail. At block 620, the barista places the prepared item on the pickup platform. At block 620, the system optionally senses the placement of the item on the pickup platform, for example via a pressure sensor incorporated into the pickup platform.

At block 624, the prepared item is removed from the queue of items in progress and at block 626 the prepared item is added to the list of items available for customer pickup. At block 628 the display displays the list of items available for pickup which now included the new prepared item, which alerts the customers that one or more items of their order are available for pickup. At block 630, the customer removes their items from the pickup platform, the picked up items are removed from the list of items available for pickup at block 632, and operation terminates at end block 634.

Advantageously, the above described mobile pick up queue system helps to automate order pickup, both by providing a visible indicator of order fulfillment and assisting with grouping multiple items together that are associated with common orders. Also advantageously, the mobile pick up queue provides accurate order status updates for customers whose orders have not yet been fulfilled.

In light of the foregoing, it should be appreciated that the present disclosure significantly advances the art of distributing customized orders to consumers. While example embodiments of the disclosure have been disclosed in detail herein, it should be appreciated that the disclosure is not limited thereto or thereby inasmuch as variations on the disclosure herein will be readily appreciated by those of ordinary skill in the art. The scope of the application shall be appreciated from the claims that follow.

What is claimed is:

1. A method, comprising:
scanning first indicia associated with an item of a customer order;
placing the item on an item pickup position of an item pickup platform; and
generating, on a display associated with the item pickup platform, second indicia for directing a customer to the item pickup position on the item pickup platform.

2. The method of claim 1, wherein the first indicia is a bar code, wherein the second indicia includes a customer name associated with the customer order and location indicia of the item pickup position on the item pickup platform, and wherein the second indicia is displayed in a list of customer orders ready for customer pickup.

3. The method of claim 1, further comprising:
sensing when the item is placed on the item pickup position by an associated sensor of the item pickup platform; and
determining the second indicia to display on the display in accordance with the scanned first indicia and the sensed item pickup position.

4. The method of claim 1, further comprising:
scanning first indicia associated with a second item of the customer order;
placing the second item at the item pickup position; and
updating the second indicia generated on the display based at least in part on the scanned first indicia of the second item.

5. The method of claim 1, further comprising:
scanning first indicia associated with a second item of the customer order; placing the second item at an adjacent item pickup position in proximity to the item pickup position; and
updating the second indicia generated on the display based at least in part on the first indicia of the second item and the adjacent item pickup position.

6. The method of claim 1, further comprising:
receiving the customer order;
placing the first indicia on the item of the customer order;
displaying third indicia associated with the customer order on the display in a list of queued customer orders; and
removing the third indicia from the list of queued customer orders subsequent to scanning the first indicia.

7. The method of claim 6, wherein the third indicia includes one or more of a customer name associated with the customer order, an identifier of a position in the list of queued customer orders, an estimated time until the customer order is anticipated to be prepared, a time associated with when the customer order was received, or one or more identifiers of other items associated with the customer order.

8. The method of claim 1, wherein the item is placed on the item pickup position subsequent to generating the second indicia and in response to displaying the item pickup position on the display.

9. The method of 8, further comprising:
scanning first indicia associated with a second item of the customer order;
updating the second indicia generated on the display based at least in part on the scanned first indicia of the second item; and
placing the second item on a second item pickup position in proximity to the item pickup position in accordance with the second indicia.

10. The method of 8, further comprising:
scanning first indicia associated with a second item of the customer order;
updating the second indicia generated on the display based at least in part on the scanned first indicia of the second item;
placing the second item on the pickup position in proximity in accordance with the second indicia.

11. An item pickup system, comprising:
an item pickup platform configured to be disposed on a counter and comprising a plurality of item pickup positions, each item pickup position configured to accept an item for pickup by a customer;
a scanner configured to scan indicia of items available for pickup by customers; and
a display configured to identify item pickup positions on the item pickup platform.

12. The item pickup system of claim 11, wherein the pickup platform comprises a plurality of shelves, each shelf including one or more item pickup positions.

13. The item pickup system of claim 11, wherein the pickup platform comprises a substantially flat mat that includes a plurality of item pickup positions.

14. The item pickup system of claim 11, wherein the display is further configured to display a first list of customer orders available for pickup and a second list of pending customer orders.

15. The item pickup system of claim 11, wherein the pickup platform includes one or more display elements for identifying items associated with customer orders.

16. The item pickup system of claim 11, wherein each item pickup position includes a sensor configured to detect the presence of an item, and wherein the display is further configured to selectively display the item pickup position when present.

17. A system, comprising:
a scanner configured to scan indicia associated with an item of a customer order;
an item pickup platform comprising a plurality of item pickup positions, each item pickup position configured to receive one or more items of a customer order;
a display configured to direct customers to associated items disposed on the item pickup positions; and
a processor configured to
receive data associated with the scanned indicia from the scanner,
determine item pickup positions associated with items of a customer order,
generate display data including indicia associated with the customer order and an associated item pickup position, and
transmit the display data to the display.

18. The system of claim 17, wherein the scanner is integrated into the item pickup platform and configured to scan items brought into proximity of the item pickup platform.

19. The system of claim 17, wherein the processor is further configured to generate a list of customer orders available for pickup and a queue of pending customer orders, and wherein the display data includes the list of available customer orders and the queue of pending customer orders.

20. The system of claim 19, further comprising:
a plurality of sensors each associated with an item pickup position and configured to detect the presence of an item placed on the item pickup position,
wherein the processor is further configured to determine item pickup positions based at least in part on sensor data from the sensors and data associated with the scanned indicia.
